(19) United States
(12) Patent Application Publication
(10) Pub. No.: US 2020/0071480 A1
(43) Pub. Date: Mar. 5, 2020

(54) ACOUSTIC GRAPHENE-CONTAINING COMPOSITIONS/MATERIALS AND METHODS OF FORMATION

(71) Applicant: The University of Adelaide, Adelaide (AU)

(72) Inventors: Anthony Charles Zander, North Adelaide (AU); Md Julker Nine, Kilburn (AU); Md Ayub, Greenacres (AU); Dusan Losic, Seaford Rise (AU); Benjamin Cazzolato, Forestville (AU); Carl Quentin Howard, Grange (AU); David Huang, Adelaide (AU)

(73) Assignee: The University of Adelaide, Adelaide (AU)

(21) Appl. No.: 16/490,116

(22) PCT Filed: Mar. 1, 2018
(86) PCT No.: PCT/AU2018/050185

§ 371 Date: Aug. 30, 2019

(30) Foreign Application Priority Data
Mar. 1, 2017 (AU) 2017900697

(51) Int. Cl. C08J 9/00; C08J 9/40; C08K 3/04; E04B 1/84

(52) U.S. Cl. CPC C08J 9/0071; C08J 9/40; C08K 3/042; E04B 1/84; C08K 2201/011; C08J 2379/02; C08J 2375/04; C08J 2201/038; C08J 2205/05

(57) ABSTRACT

A low density foam material and methods for making such, comprising self-assembled graphene oxide in foam is described having high performance acoustic absorption as well as increased moisture insulation and fire-retardant properties. The graphene oxide material is inserted or distributed within openings of open cell/pore foam material resulting in a novel foam material that has increased acoustic absorption properties.

### FIELD OF THE INVENTION

The present invention relates to acoustic or sound dampening material and in particular to acoustic or sound dampening composite material containing graphene or graphene oxide (GO) or reduced graphene oxide (rGO).

### BACKGROUND

Sound absorbing materials can be used in a variety of locations and act generally to absorb sound energy rather than reflect it. Due to their ability to absorb sound they can be utilized in locations close to the source of the noise, such as electric motors, mechanical engine, and also used close to a receiver.

Sound absorbing composite material usually includes porous absorption materials such as melamine foam, polyurethane foam, metal foam, and ceramic foam, which are commonly used for controlling noise at mid and high frequencies.

Porous sound absorbing materials work by having sound propagation occur in a network of interconnected pores in which the interaction of the sound wave with the walls of the pores results in dissipation of the sound energy. However, in order to provide effective absorption of noise in the mid and high frequency ranges a relatively thick section of the porous composite material is required.

As such, there is a requirement to utilize thick layers of porous sound absorbing material in order to effectively achieve noise absorption at low frequencies. This then results in having a heavy load of the composite material being used which takes up considerable space, thus making such material ineffective from both a cost and size perspective.

Experimental and theoretical studies on the acoustic absorption mechanism of known materials show that the absorption performance (coefficient) is significantly dependent on the microscale pores and the pore-size distribution in the porous structure. The pore modification of these absorption materials contribute in controlling important absorption dependent parameters such as flow resistivity, porosity, tortuosity, rigidity, compressibility, and other characteristics including thermal and electrical conductivity.

There is a need for new multifunctional composite materials with advanced acoustic absorption capabilities applicable to a wide range of applications.

### OBJECT OF THE INVENTION

It is an object of the present invention to overcome, or at least substantially ameliorate, the disadvantages and shortcomings of the prior art.

Other objects and advantages of the present invention will become apparent from the following description, taken in connection with the accompanying examples, wherein by way of illustration and example, several embodiments of the present invention are disclosed.

### SUMMARY OF THE INVENTION

According to the present invention, there is provided a graphene-based composite foam material comprising an open cell/pore foam material having a graphene-based material inserted or connected or distributed within.

In preference, the graphene-based material is inserted or distributed within the opening of the open cell/pore foam.

In preference, the graphene-based material inserted or distributed within the opening of the open cell/pore foam results in formation of a portion of closed cell/pores in the open cell/pore foam material. The graphene-based materials are partially/fully interconnected with the limbs of the porous foam skeleton.

In preference, the open cell/pore foam material is a melamine foam.

In preference the open cell/pore foam material is a polyurethane foam, ceramic foam, loofah sponge, natural foam or metal foam.

In preference, the open cell/pore foam is a functionalized foam that can be electrostatically integrated with preferred graphene derivatives (i.e. graphene oxide).

In preference, the open cell/pore foam material is intercalated with the graphene-based material.

In preference, the graphene is derivitized graphene and/or graphene oxide and/or reduced graphene oxide and/or other functionalized graphene.

In preference, the graphene-based material is graphene oxide.

In preference, the graphene-based material is in the form of a liquid crystal.

In preference, the graphene based material is functionalized with groups selected from amine groups, hydroxyl groups, carboxyl groups, epoxy groups, ketone groups, aldehyde groups or a mixture thereof.

In preference, the composite material is an acoustic absorbing material.

In a further form of the invention there is a method of preparing a graphene-based composite, the method comprising (i) providing a concentration of a graphene-based material and a porous polymeric material in a liquid, (ii) sonicating the liquid, wherein the sonication promotes incorporation of the graphene-based material into and/or over the pores of the polymeric material, and (iii) removing the liquid to afford the graphene-based composite.

In preference, the process of removing of liquid in (iii) promotes self-assembly/formation of layers of graphene-based material over at least a portion of the pores of the open-cell/pore materials.

In preference, the process of removing of liquid in (iii) promotes formation of layers of graphene-based material over at least a portion of the pores of the open-cell/pore material to close at least a portion of the pores.

In preference, the porous polymeric material is a porous open cell foam polymeric material.

In preference, the layers of graphene-based material are self-assembled thin layers.

In preference, the thin layers are lamella.

In preference, the density of the graphene-based acoustic material is between 10 kg/m³-1000 kg/m³.

In preference, the density of the graphene-based acoustic material is between 5 kg/m³-30 kg/m³.

In preference, the density of the graphene-based acoustic material is between 10 kg/m³-25 kg/m³.

In preference, the density of the graphene-based acoustic material is between 11 kg/m³-22 kg/m³.

The graphene-based composite of the present invention, in one embodiment, provides a new lamellar micro-structure by integrating additional flakes (or small plates) of graphene oxide into melamine/polyurethane/ceramic foam that randomly block at least a portion of existing pores or cells and modify the pore distribution, that is to alter the open pore/cell to closed pore/cell ratio. These modifications to the pore distribution via the creation of a graphene assisted micro-lamellar structure of foams provides multiple reflections, scattering of incident acoustic waves, changing the properties of controlling parameters of sound absorption and therefore making them efficient for enhanced acoustic absorption.

Many variations and modifications may be made to the above embodiments and preferred embodiments, and are merely possible examples of the implementation of the present invention to provide a better understanding of the principles of the disclosure. Other variations and modifications may be made to the above without departing substantially from the scope of the present disclosure.

### DETAILED DESCRIPTION

Used herein, the term “graphene” refers to laminate sheets of carbon atoms that may be a single layer or multilayer structures.

The term “graphene oxide” or “GO” refers to oxidised graphene that may have functional groups.

The term “open pores” or “open cell” in connection with a foam refers to pores or cells in the foam structure that are open and may be through pores/cells, in which pores/cells interconnect with other pores/cells, or blind pores/cells that are closed at one end.

The term “reduced graphene oxide” or “rGO refers to removal of oxygen functional groups from oxidised graphene by chemical or thermal reduction process.

Reduced graphene oxide is both chemically and physically different to graphene oxide due to the loss of its oxygen functional groups. The degree to which graphene oxide is reduced can be varied, with that variation being reflected in the amount of oxygenated groups remaining. Where graphene oxide is not fully reduced it is often referred to in the art as partially reduced graphene oxide. Reduced and partially reduced graphene oxide are less hydrophilic than graphene oxide. Reduced graphene oxide is sometimes referred to in the art simply as graphene as an indication that substantially all oxygenated groups have been removed. Techniques for reducing or partially reducing graphene oxide are well known in the art. For example, graphene oxide can be reduced or partially reduced by chemical or thermal reduction.

The term “melamine foam” refers to foam material that consists of a formaldehyde-melamine-sodium bisulphate copolymer.

In the context of the present invention the expression “graphene-based” composite is intended to mean the composite has a composition comprising graphene, graphene oxide, partially reduced graphene oxide, reduced graphene oxide or a combination of two or more with additional polymeric crosslinking agent thereof. The expression “graphene-based” material may therefore be used herein as a convenient reference to graphene (material or sheets), graphene oxide (material or sheets), partially reduced graphene oxide (material or sheets), reduced graphene oxide (material or sheets) or a combination of two or more thereof.

### BRIEF DESCRIPTION OF THE DRAWINGS

By way of example only, an embodiment of the invention is described more fully hereafter, with reference to the accompanying drawings, in which:

FIG. 1 shows a schematic of the synthesis of GO assisted lamellar structure with tunable densities, a. schematic presentation of synthesis GO-lamellar structure in melamine skeleton, b. self-assembly of microscopic GO sheets to macroscopic interconnected GO film forming lamellar structure, c. SEM of control-MF (melamine foam) skeleton with a density of 9.84 kg/m3, d. sample-MFGO-1 at a density of 12.39 kg/m3, e. sample-MFGO-3 at a density of 18.77 kg/m3, f sample-MFGO-5 at a density of 24.12 kg/m3.

FIG. 2 shows graphene oxide and melamine foam structure. (a-c) morphological image of GO by TEM, SEM and AFM. (d-e) optical image of untreated melamine foam and GO assisted lamellar foam. f. SEM of GO assisted lamellar structure. g. melamine skeleton with open cell structure, (h-i) close cell structure of the treated samples.

FIG. 3 shows the mechanical properties of GO assisted lamellar structure. a. samples with control-MF and GO assisted lamellar foam (MFGO) at different densities, b. load of 500 g applied on the samples to realize enhanced mechanical strength of the samples of different density, c. compression cycles of the samples for two different compression percentage.

FIG. 4 shows the wettability and moisture absorption/desorption of the samples before and after chemical and thermal reduction. a. Change in wettability (of control-MF, MFGO-3, MFrGO-3 samples) before and after reduction, (b and c). Moisture absorption and desorption of MFGO and MFrGO samples compared with control-MF, (d, e, and f). High temperature stability and flame-retardant properties of the melamine and GO loaded melamine structure. a) MF control, b) MFGO-3, c) MFrGO-3.

FIG. 5 shows the acoustic absorption of GO assisted lamellar structure, a. Acoustic absorption of MFGO samples of five different densities (12.39 to 24.12 kg/m³) compared with control-MF for a thickness of 26±0.5 mm. b. Normalized acoustic activity based on GO loading. c. The enhancement (%) of acoustic absorption of lamellar structures for both MFGO and MFrGO samples (26 mm thickness) compared with control-MF d. Absorption performance of untreated (control-MF) and GO treated melamine foams (MF) showing the effect of GO on enhancing the acoustic absorption of melamine foam and shifting the absorption peak towards the low frequencies.

FIG. 6 shows the effect of highly loaded GO at reduced density (after reduction) in low frequency absorption. Acoustic absorption of highly loaded GO in the structure and comparison before and after reduction of GO-based lamella with unchanged structure for, a. two different densities (MFGO-3 and MFGO-5) and b. for two different thicknesses of MFGO-5.

FIG. 7 shows the effect of GO on providing similar absorption at mid to high frequencies for a (50%) reduced absorber thickness by a comparison of acoustic absorption performance of 39±1 mm control-MF and 18±0.5 mm MFrGO-5 for an equivalent density of 18.09 kg/m³.

FIG. 8 shows the effect of GO and r-GO on sound absorption for an equivalent absorber thickness of 18±0.5 mm and for equivalent masses (density) of MFGO-5 (24.12 kg/m³) and MFrGO-5 (18.09 kg/m³) highlighting the greater or similar absorption of MFGO and MFrGO for an equivalent thickness and mass of control-W. Here, compressed melamine foams of MF-1 (24.12 kg/m³) and MF-2 (18.09 kg/m³) were used to create samples of untreated (control-MF) foam of equivalent thicknesses and masses of MFGO and MFrGO.

FIG. 9 shows acoustic performance of commercially available high-performing absorption material Basotect® foam (from BASF) compared with that of the GO-assisted Basotect® foam and GO-assisted melamine foam.

FIG. 10 shows enhanced flow resistivity of different density lamellar structures (MFGO-1, MFGO-3, MFrGO-3, MFGO-5, and MFrGO-5) compared with Control-MF.

FIG. 11 describes the mechanism of enhanced acoustic absorption through graphene-based lamellar structure in porous structure.

FIG. 12 displays the examples of different kind of porous materials (Melamine foam, Polyurethane (PU) foam and loofah sponge) of open cell foam used for fabrication of graphene-based lamellar structures.

### DETAILED DESCRIPTION OF THE INVENTION

General Fabrication Method:

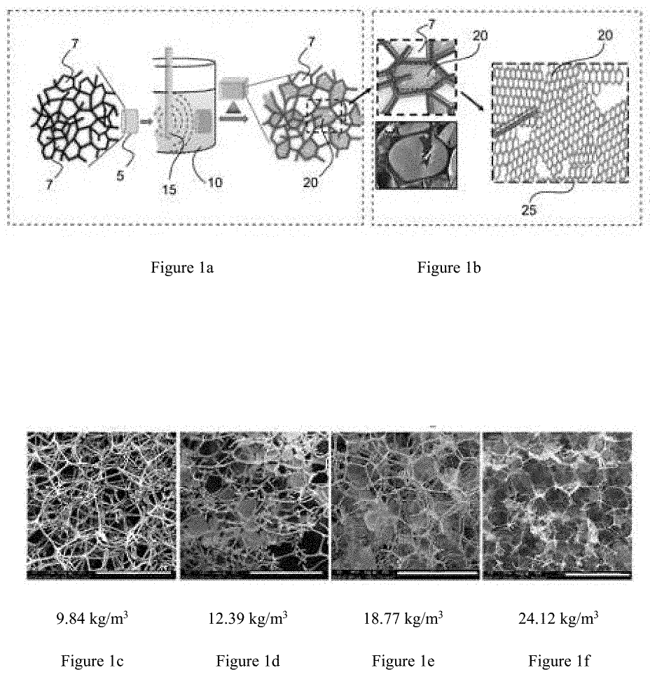

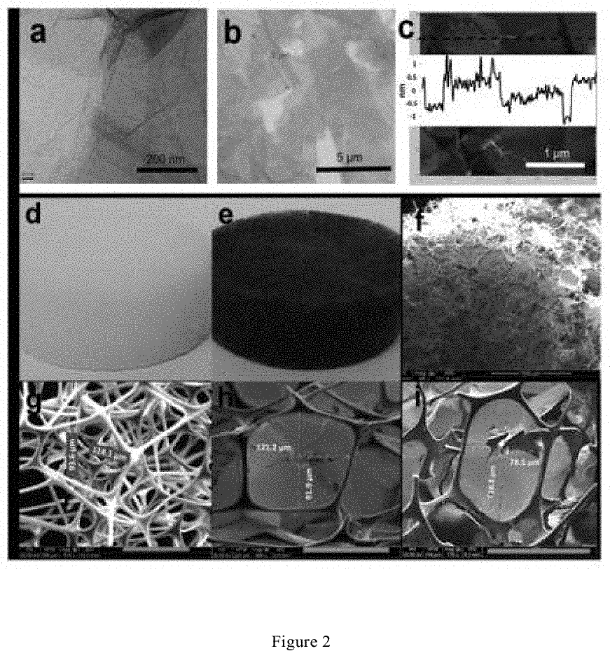

The graphene oxide (GO) liquid crystals (LCs) in a large range of concentrations (0.5-10 mg/ml) can be used for fabricating such lamella, or thin layer, structure in the melamine or other polymer foams skeleton as shown in FIG. 1a. In the typical procedure the melamine foam 5, which has open pores 7, is dipped in the GO LCS solution 10 (Milli-Q water) and sonicated 15 over 10-60 minutes in order to form the GO liquid crystals inside pores 20. The sonication time depends on the concentration of the GO liquid crystals and can vary from 10 min to 30 min for a range of concentrations between 1 mg/ml to 10 mg/ml. Temperatures for sonication can vary between ambient room temperature up to 60° C., which depends on the concentration of the GO liquid crystals and viscosity of the liquid.

Other solutions may be used as the liquid for the GO LCS, including, but not limited to, water, DMF, NMP, THF, ethylene glycol, ethanol either alone or in combination.

Other open cell foams can be utilized in the present invention, such as, but not limited to open cell foams based on melamine, polyurethane metal or ceramic based foams. In other forms of the invention, combinations of two or more of the mentioned open cell foams are used. The person skilled in the field would appreciate that other open cell foams would be suitable for use in the present invention on the basis that the foam has the functional groups (for example amine, carboxyl, ketone, aldehyde functional groups) that can electrostatically integrate with the GO based liquid crystals.

The self-assembly of GO in the structure occurs during curing stage to form interconnected lamella structure as shown in FIG. 1b, where the GO is inserted (intercalated) into the open spaces 7 between the foam structure, such as into the open pores/cells and forms a cap or cover over the open pore/cell to at least partially close the pore/cell 20. Some of the GO may pass deeper into the open pore/cell structure but can still form a layer or lamella to at least partially close the pore/cell or reduce the depth of the pore/cell. The density of the structure can be controlled by using different concentration of GO LCs. Further reduction of GO into reduced GO is done following two step reduction introducing hydrazine vapour and thermal annealing in vacuum oven to change the basic properties of the structure such as wettability, conductivity, structural integrity.

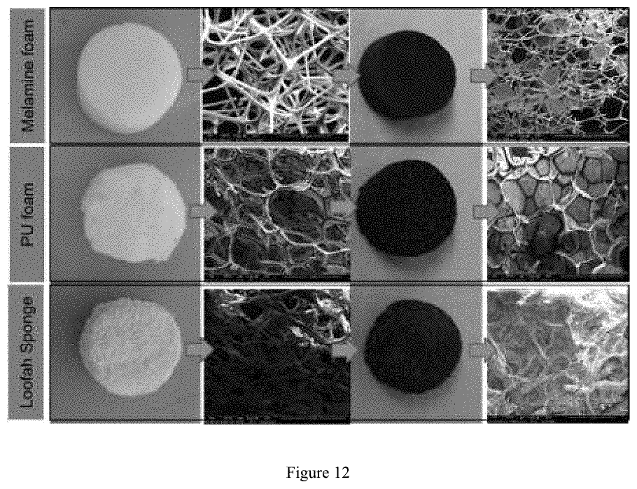

Three examples of porous materials have been used as shown in FIG. 12 which include melamine foam, polyurethane foam and loofah sponge. These examples and the formation of lamella network in different kind of open cell structures testifies that the process is applicable for any kind of open-cell porous structures.

Structural Properties

The exfoliated GO and the physical properties of them are shown in FIG. 2, by transmission electron microscope (TEM), scanning electron microscope (SEM) and atomic force microscope (AFM). The TEM of GO sheets confirms the regular exfoliation with an average dimensional length of 4-5 μm (area of ˜20 μm2) confirmed by SEM while the AFM confirms the thickness of few layer synthesis of GO. The self-assembly of negatively charged GO sheets in the melamine network forms a macroscopic film that interconnects the positively charged limbs of the cell to close the pore either fully or partially. This is how close cell structures can be formed, connecting graphene sheets with various densities between 10 kg/m³ and 25 kg/m³ with the open and close cell ratio between 90% and 10%. The average limb to limb dimension of the cell varies between 80 μm and 130 μm with an apparent open and close cell area of 0.0072 mm² to 0.011 mm².

Light Weight:

Materials incorporating the present invention have a density between 10 and 25 kg/m³ that show significant improvement in acoustic absorption at low frequency, although the density of the material is dependent on a number of factors such as where the foam is to be used, how much foam is to be used and other materials incorporated into the foam. In some applications the density of the foam may be between 100-1000 kg/m³, and other densities are considered to fall within the scope pf the invention. With the proposed structure and density, the thickness of conventional foam can be reduced to half to achieve similar acoustic absorption. For example, a 40 mm thick melamine foam shows acoustic activity equivalent to the 20 mm thick sample of lamella structure with a density of 21.41 kg/m³.

Compressibility, Mechanical Strength:

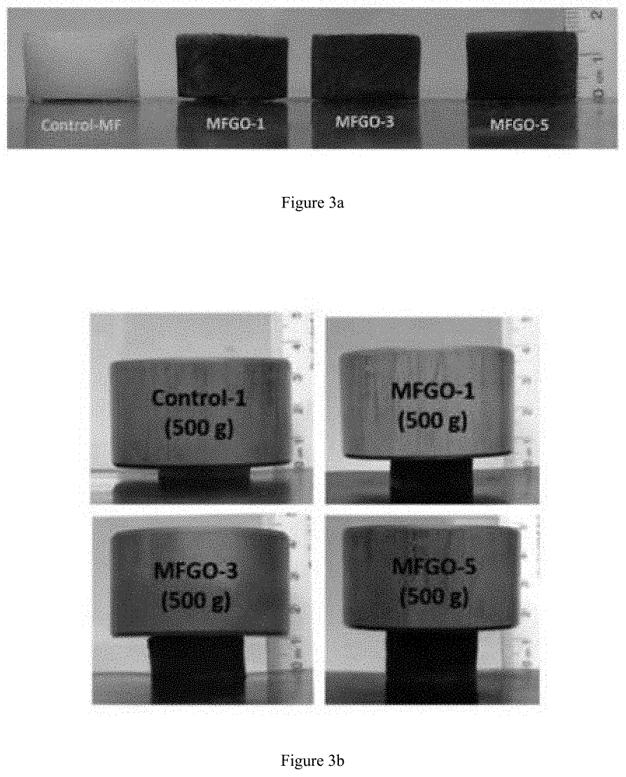

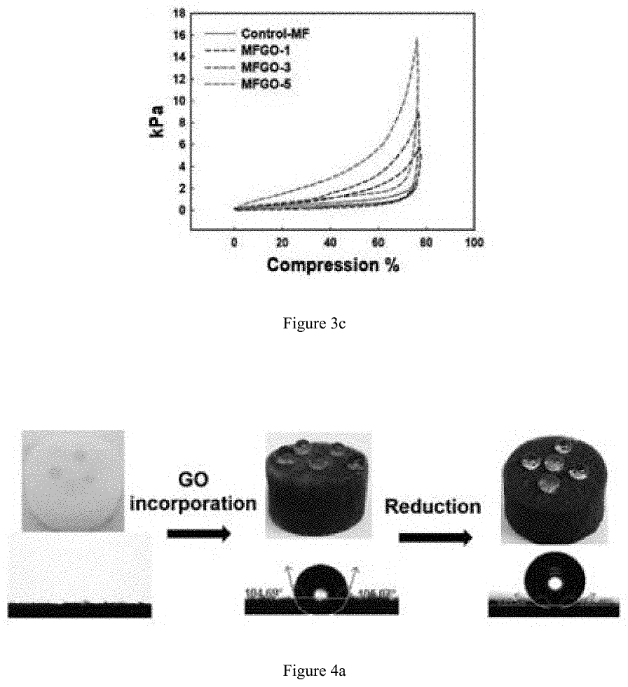

The material is highly compressible and possess strong mechanical strength to resist a pressure up to 15 kPa as shown in FIG. 3.

Mechanical compressibility of the samples was significantly dependent on their density. The apparent densities of the samples were measured according to ASTM D 1622-08 for 5 samples of each type after moisture conditioning at 25° C. for 24 hrs. Mechanical compression test of the samples was performed using a Tensile/Compression/Bending tester (Deben, 200N, UK). The speed of the jaw was set as 1.5 mm/minute for gradual compression under different compression length.

The standard (ASTM C-522) was used to measure the static airflow resistance of each sample. The ASTM C-522 standard is a direct airflow method in which unidirectional airflow is passed through test specimen to create pressure difference between upstream and downstream flow to measure the resulting pressure drop between two free faces of specimen in a tube. The test rig consists of an acrylic tube connected to a line of compressed air with pressure regulator, flowmeter, and manometer. The specimen was mounted on an acrylic tube attached to the compartment. A digital manometer (475 Mark III, Dwyer, USA) is used to measure the pressure drop of airflow across the installed specimen after the flow has reached a steady stage. The resistance of airflow was defined here as the specific airflow resistivity (σ) per unit thickness (l) which is obtained using the Equation-1.

$$σ = \frac{{P}_{1} - {P}_{2}}{Ul / A} \qquad ( Equation 1 )$$

where, P1, P2 are upstream and downstream static pressure to calculate pressure drop across the sample of 1 thickness and cross-sectional area of A, whereas flowmeter provides a volumetric flow rate (U) of air.

Reduced Moisture Absorption:

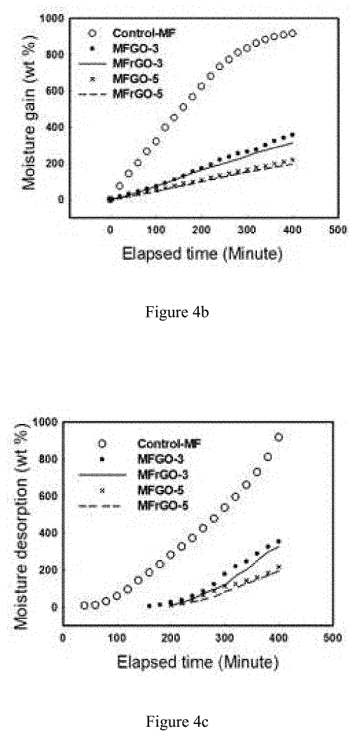

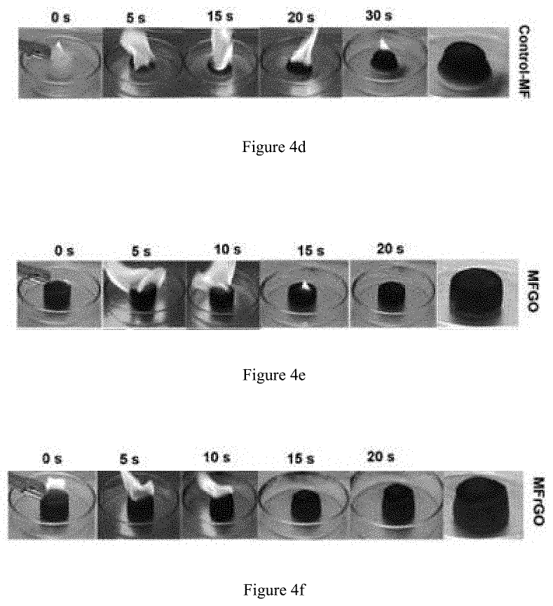

The graphene-based composite material of the present invention can be altered as required by using materials from hydrophilic to superhydrophobic by controlled reduction. Therefore, the moisture absorption rate in saturated air is very low. Such materials with low moisture absorption rate are expected to perform better for many years even in humid environments. The wettability and moisture absorption results are shown in FIG. 4(a-c).

Fire Retardant:

The graphene-based composite material of the present invention also exhibits fire-retardant properties. During thermal decomposition of melamine, the release of nitrogen gas helps to reduce fire hazards. On the other hand, impermeable graphene sheet works as a carbon donor or charring agent to resist the access of oxygen to unburnt area. The flame retardancy has been shown in FIG. 4(d-f).

The as-prepared samples of Control-MF, MFGO-3, MFGO-5, MFrGO-3, and MFrGO-5 were placed 20 mm apart from the mouth of mist generator (commercial humidifier) for moisture absorption and left at 35% RH at a temperature of 25° C. for moisture desorption. The change of mass was monitored in every 10 min interval for both moisture absorption and desorption cycle. The samples of Control-MF, MFGO-3, and MFrGO-3 (diameter of 26.5 mm and length of 14 mm) were soaked with 10 μl of gasoline to set fire in order to test structural and thermal stability during fire.

Electrical Conductivity:

The graphene can be modified to change or alter the electrical conductivity by controlling the degree of the reduction of graphene oxide used in the structure that helps making the lamella/thin layer network electrically conductive. The bulk resistance of the material is varied between 250 and 400 kΩ after chemical and thermal reduction. Such electrically conductive materials with good acoustic absorption can be used as an electromagnetic shield.

Acoustic Absorption Performance: [Melamine Foam Impregnated with GO/r-GO Coating]

Open-celled melamine foam usually provides a good absorption performance in the mid to high frequency range. The absorption performance of the foam can be improved further through a chemical modification of the foam using graphene oxide (GO) suspension while maintaining the same material thickness and changing the bulk density of the materials.

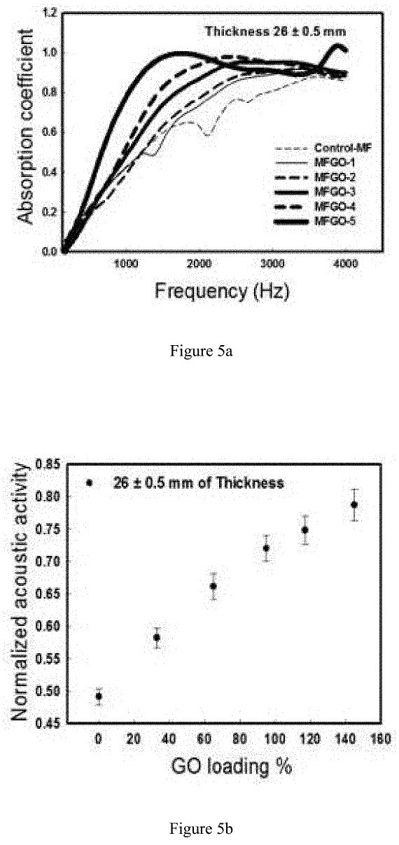

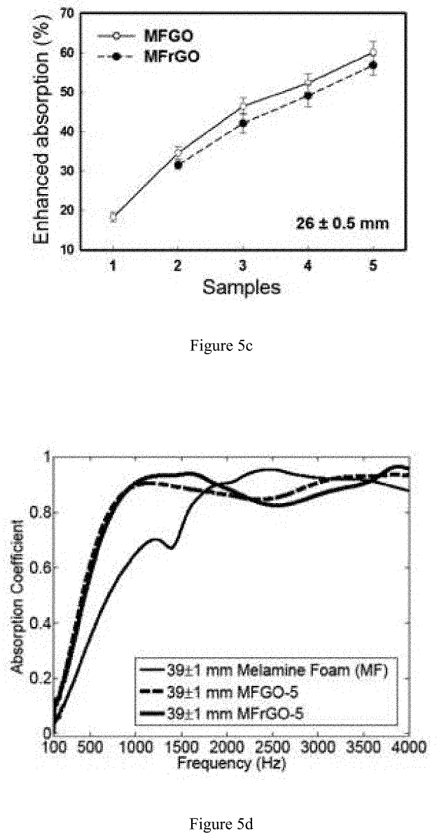

As shown in FIG. 5(a), acoustic absorption of melamine foam can be enhanced by up to 10% in the frequency range above 1500 Hz using graphene oxide (GO) coating with the density of MFGO samples as low as 20 mg (12.39 kg/m³) in the foam and with the same material thickness.

Absorption can be enhanced further in the lower frequency range by increasing the GO loading in the foam and can be increased by up to 60% (as shown in FIG. 5(c)) in the broadband frequency range between 500 Hz to 3500 Hz with the density of MFGO samples as high as 24.12 kg/m³. As can be seen in FIG. 5(a), the sound absorption is doubled with the highest density sample (MFGO-5) at some frequencies. The increase in loading percentage of GO also shows an almost linear increase in acoustic activity as presented in FIG. 5(c). In addition the GO loading contributes to shift the highest absorption peaks of the melamine foam towards the lower frequency making it suitable in applications for low frequency sound absorption. Further proof of the enhancement of acoustic absorption performance at the low frequencies with the implementation of the impregnation of the GO material can be observed in the results presented in FIG. 5(d).

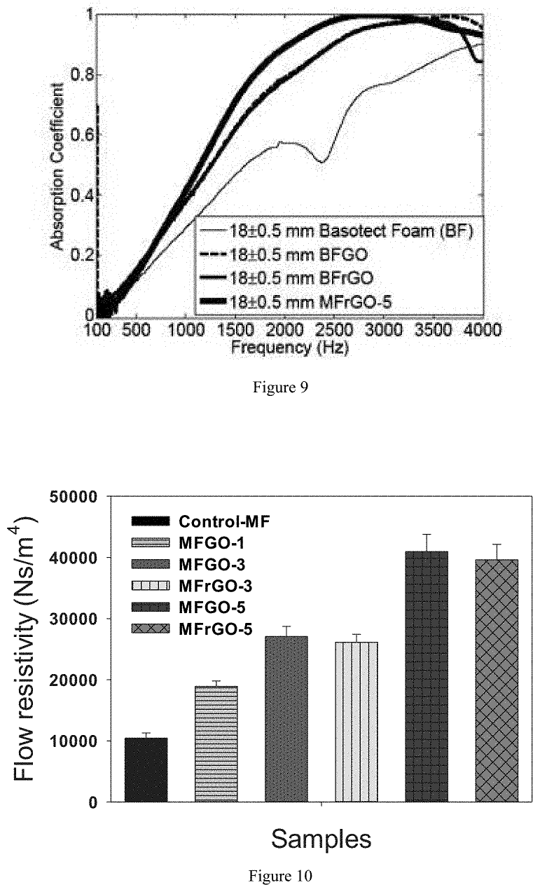

The GO-assisted/incorporated foam can provide greater absorption performance to commercially available high-performance absorption foam such as Basotect® G⁺ foam manufactured by BASF, as observed in our laboratory test results shown in FIG. 9. A similar approach of GO coating can be implemented for Basotect® foam, in which GO assisted Basotect® foam provides enhanced absorption performance to uncoated (control) Basotect® foam as shown in FIG. 9.

The normal-incidence acoustic absorption coefficient of the Control-MF, MFGO, and MFrGO samples was measured in an impedance tube using two microphones in accordance with the ASTM E1050 standard. A custom-made copper impedance tube with an internal diameter of 25.4 mm was used to measure the normal incidence acoustic absorption coefficient of the absorber samples. The impedance tube setup consists of a compression driver, a simple holder and a pipe section made of copper tube which holds the two microphones that measure the acoustic pressure in the tube.

The instrumentation comprised two ¼-inch Brüel & Kjaer (B&K) array microphones type 4958, a four channel B&K Photon+™ data acquisition system and LDS Dactron software. The B&K microphones have a free field frequency response (re 250 Hz) of ±2 dB within the frequency range 50 Hz to 10 kHz. A pistonphone calibrator (B&K type 4230) was used to calibrate the microphone sensitivity to 94 dB at 1 kHz. Measurement data was acquired with 4 Hz frequency resolution, with a sampling interval of 7.6 μs (with 12800 lines and 32768 points) and sample records of finite duration of approximately 106 s for 300 averages.

The acoustic activity (normalized absorption coefficient, a) of the samples over a broad range of frequency spectrum between f₁=128 Hz to f₂=4000 Hz was also calculated to justify the effectiveness of the lamella samples based on the loading percentage of GO in the melamine skeleton. The normalized acoustic activity (α) was calculated using the Equation-2:

$${α}_{normalized} = \frac{1}{( {f}_{2} - {f}_{1} )} {\int }_{f 1}^{f 2} α ( f ) df \qquad ( Equation \text{-} 2 )$$

where, α (f) is frequency dependent absorption coefficient, f₁ and f₂ represent the lower and upper frequency limit at which the activity is calculated.

Material Thickness and Mass Requirement:

The proposed acoustic absorbers of the present invention are based upon open-celled foam (such as melamine foam, polyurethane foam) (FIG. 12) impregnated with a graphene oxide (GO) coating. This changes the bulk density of the material, thus increasing the weight of the material. However, the novelty of the GO coated material is that it can provide similar acoustic absorption for a wideband frequency range for an equivalent mass of an uncoated foam with a reduction of 50% in the material thickness. Alternatively, the proposed material can be chemically treated to remove oxygen functional groups and moisture from the GO structure which makes the material contain up to 30% reduced density of the GO foam.

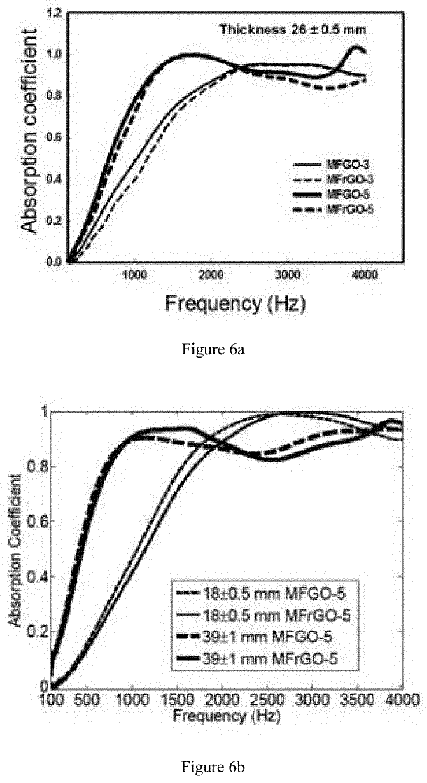

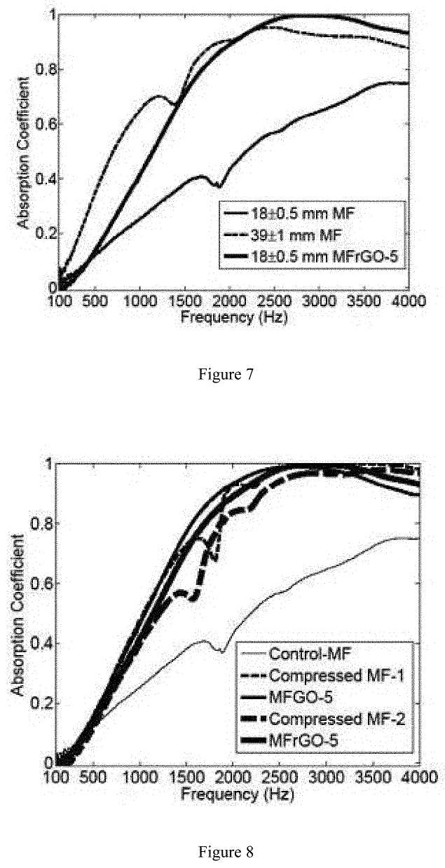

As shown in FIG. 6, open celled foam with reduced graphene oxide (rGO) can make the material light weight by reducing 30% of the mass (density) for an equivalent thickness of GO-coated foam and can provide an equivalent acoustic absorption of the GO coated foam. In addition, at mid to high frequencies the rGO-coated foams can provide absorption performance equal to uncoated foams for an equivalent mass of the absorber with a reduction of 50% in the material thickness, as displayed in FIG. 7. For an equivalent thickness and mass, both GO and r-GO coated materials can provide greater or similar acoustic absorption performance compared with the uncoated materials. A comparison of these absorption performances can be seen in FIG. 8. Overall, both GO- and rGO-coated foams exhibit excellent absorption performance in terms of reduced thickness and mass of the required materials for the absorber.

Non-Acoustical Properties:

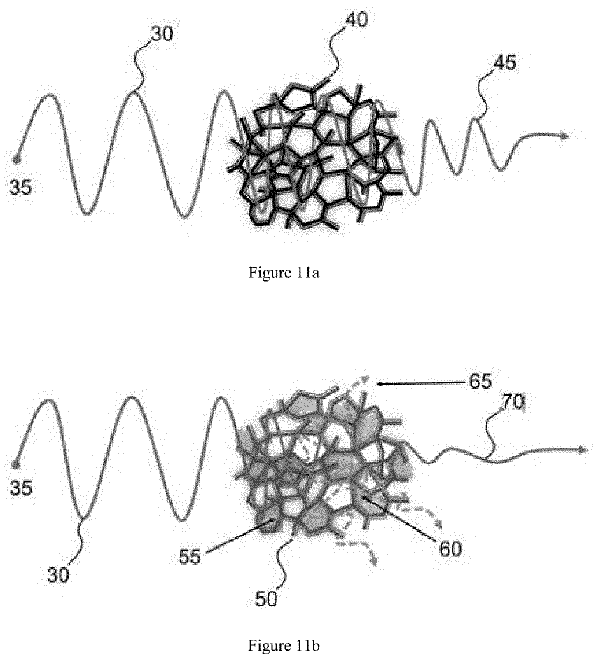

The random blocking of pores in open celled porous structures by the method of the present invention creates irregularity in the wave propagation path and makes the flow path more tortuous. This reduces the porosity and increases the flow resistivity and tortuosity of the material. Investigations show that the flow resistivity and tortuosity of the material changes linearly with the GO loading in the materials. The measured flow resistivity, as shown in FIG. 10, confirms that the flow resistance of MFGO increases with the percentage of GO loading (sample density). The flow resistivity of the highest density lamellar structure (MFGO-5) was measured as 40 932 Ns m⁻⁴ which is about four times higher than that of control-MF (≈450 Ns m⁻⁴). As shown in FIG. 11A sound waves 30 from a sound source 35 pass into the open cell structure 40 and are relatively unhindered resulting on a low level of attenuation of the sound wave 45 after passing through the open cell structure 40. In comparison, sound waves 30 from the sound source 35 passing into the semi-open cellular structure 50 are faced with graphene lamella blockage 55 which creates high air-flow resistance. This result in a high level of tortuosity in wave propagation 60 and internal reflection of sound energy 65 that leads to a greatly attenuated level of residual noise 70.

As can now be appreciated, the method and compositions provided by one or more forms of the present invention show:
a. An increased acoustic absorption, in some forms up to 60% more acoustic absorption than commercial foam attributed to the change in tortuosity, porosity, rigidity and flow resistivity.
b. Effective in achieving good acoustic absorption characteristics at a frequency as low as 500 Hz and can double the noise reduction performance at around 1 kHz over conventional foams.
c. A material that can be tuned to vary mechanical, thermal and electrical properties as required;
d. Increased flame retardancy and/or reduction in production of toxic volatile material during fire hazards;
e. Reduction in capacity to absorb and/or resist absorption of moisture.

The material has significant potential to resist flame propagation and toxic volatiles release during fire hazards.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. A graphene-based composite foam material comprising an open cell/pore foam material having a graphene-based material inserted or distributed within.

2. The graphene based composite of claim 1, wherein the graphene-based material inserted or distributed within openings of the open cell/pore foam.

3. The graphene based composite of claim 1, wherein the graphene-based material inserted or distributed within openings of the open cell/pore foam results in formation of a portion of closed cell/pores in the open cell/pore foam material.

4. The graphene based composite of claim 1, wherein the open cell/pore foam material is at least one foam material selected from the group consisting of melamine foam, polyurethane foam, ceramic foam, loofah sponge, natural foam and metallic foam.

5. The graphene based composite of claim 1, wherein the open cell/pore foam material is intercalated with the graphene-based material graphene.

6. The graphene based composite of claim 1, wherein the graphene is derivitized graphene and/or functionalized graphene.

7. The graphene based composite of claim 1, wherein the graphene-based material is graphene oxide.

8. The graphene based composite of claim 1, wherein the composite material is an acoustic absorbing material.

9. A method of preparing a graphene-based composite, the method comprising (i) providing a concentration of a graphene-based material and a porous polymeric material in a liquid, (ii) sonicating the liquid, wherein the sonication promotes incorporation of the graphene-based material into and/or over the pores of the polymeric material, and (iii) removing the liquid to afford the graphene-based composite.

10. The method of claim 9, wherein the process of removing of liquid in (iii) promotes formation of layers of graphene-based material over at least a portion of the pores of the polymeric material.

11. The method of claim 9, wherein the process of removing of liquid in (iii) promotes formation of layers of graphene-based material over at least a portion of the pores of the polymeric material to close at least a portion of the pores.

12. The method of claim 9, wherein the porous polymeric material is a porous open cell foam polymeric material.

13. The method of claim 9, wherein the layers of graphene-based material are thin layers.

14. The method of claim 9, wherein the thin layers are lamella.

15. The method of claim 9, wherein the density of the graphene-based material is between 5 kg/m3-30 kg/m3.

16. The method of claim 9, wherein the density of the graphene-based material is between 10 kg/m3-25 kg/m3.

17. The method of claim 9, wherein the density of the graphene-based material is between 11 kg/m3-22 kg/m3.

18. The method of claim 11, wherein the density of the graphene-based acoustic material is between 10 kg/m3-1000 kg/m3.
